(19) United States
(12) Patent Application Publication
(10) Pub. No.: US 2024/0303136 A1
(43) Pub. Date: Sep. 12, 2024

(54) TEXT VERTICALIZATION IN A SOFTWARE APPLICATION

(71) Applicant: SAP SE, Walldorf (DE)

(72) Inventor: Thomas Decker, Bad Schoenborn (DE)

(21) Appl. No.: 18/118,501

(22) Filed: Mar. 7, 2023

(51) Int. Cl. G06F 9/54; G06F 9/451; G06F 16/31; G06F 16/338

(52) U.S. Cl. CPC G06F 9/541; G06F 9/451; G06F 16/31; G06F 16/338

(57) ABSTRACT

Various examples are directed to systems and methods of generating a user interface in a computing system. The computing system may execute a software application comprising a plurality of source objects. A verticalization layer of the software application may receive a request to modify a terminology used by the software application to render source objects from a first terminology to a second terminology. The verticalization layer may access a verticalization object associated with the first source object and the second terminology to obtain at least one second terminology text string associated with the first source object and the second terminology. The verticalization layer may replace the at least one text string at the verticalization data structure with the at least one second terminology text string.

### BACKGROUND

Software applications, including enterprise resource planning (ERP) applications, include text strings that are provided to users at different stages in application processing. For example, a software application may provide messages to human users, where the messages include human-readable text conveying information to a human user, such as information describing the operation of the software application. In another example, a software application may provide a user interface screen for receiving input data from the user. The user interface screen may include human-readable text describing input fields in the user interface screen.

### BRIEF DESCRIPTION OF DRAWINGS

The present disclosure is illustrated by way of example and not limitation in the following figures.

FIG. 1 is a diagram showing one example of an environment comprising a computing system executing an ERP application in conjunction with a database management system (DBMS).

FIG. 2 is a flowchart showing one example of a process flow that may be executed in the environment of FIG. 1 to provide a rendered source object to a user.

FIG. 3 is a flowchart showing one example of a process flow that may be executed in the environment of FIG. 1 to change the terminology being implemented by the ERP application.

FIG. 4 is a diagram showing one example implementation of the ERP application of FIG. 1.

FIG. 5 is a diagram showing another example implementation of the ERP application of FIG. 1.

FIG. 6 is a flowchart showing one example of process flow that may be implemented by the verticalization layer to create a new verticalization object.

FIG. 7 is a flowchart showing one example of a process flow that may be executed by the verticalization layer to import a verticalization object.

FIG. 8 is a block diagram showing one example of an architecture for a computing device.

FIG. 9 is a block diagram of a machine in the example form of a computer system within which instructions may be executed for causing the machine to perform any one or more of the methodologies discussed herein.

### DETAILED DESCRIPTION

A database management system (DBMS) can be implemented as part of a suite of software applications that execute together. For example, the DBMS may support various client processes that utilize the DBMS to manage data. In some examples, a DBMS is implemented with a suite of processes that implement an enterprise resource planning (ERP) software application. ERP applications are often used in conjunction with a DBMS to manage various different aspects of business operations. An example ERP software application is the S/4 HANA product available from SAP SE of Waldorf, Germany.

The ERP application generates and utilizes the data stored at the database management system to perform different enterprise operations. For example, an ERP application supporting a human resources operation may store employee records at the DBMS. An ERP application supporting accounting may use records managed by the DBMS to perform various accounting-related tasks such as generating and recording invoices, purchase orders, and the like. An ERP application supporting human resources management may perform various tasks related to, for example, using data managed by the DBMS to generate and manage payroll, benefits, and the like. Other ERP applications may perform other business tasks.

Various aspects of an ERP application involve presenting human-readable text to users. For example, an ERP application may provide users with messages that describe the operations of the ERP application. Also, in some examples, an ERP application may provide user interface screens to the users. The user interface screens may include text to explain the contents of the user interface screen and/or to describe desired user inputs associated with input fields of the user interface.

It is desirable for a single software application, such as an ERP application, to be implemented in different language contexts where users speak different languages and in different business contexts where users use different terminologies. Consider an example manufacturing entity utilizing an ERP application for managing accounting-related tasks. The manufacturing entity may refer to materials and manufacturing plants. Consider another example retail sales entity utilizing the same ERP application for accounting tasks. The retail sales entity may refer to items and retail locations. For the purpose of the accounting tasks performed by the ERP application, the item used by the retail sales entity may be equivalent to the materials used by the manufacturing entity. Further, the manufacturing plants used by the manufacturing entity may be equivalent to the retail locations used by the retailers.

As a result, it may be desirable for a software application, such as an ERP application, to support different terminologies. This may allow support of a variety of users who use the application in different business contexts and different language contexts. In various examples, a software application may be configured to support different terminologies by modifying the underlying source code itself. For example, a provider of the software application may release different versions of the application corresponding to different terminologies. The relevant terminologies may be incorporated into the code of the respective versions as literals. An entity utilizing the application may acquire and use the version of the application code corresponding to its desired terminology.

This approach, however, has certain disadvantages. One disadvantage is related to the development cycle for the software application. The professionals who develop software applications, such as ERP applications, often include software developers who write code as well as linguistics professionals who create text strings for different terminologies (e.g., for different business contexts and language contexts). When the text strings are included as literals in the code itself, the development cycle of the software developers may need to be paused while the linguistics professionals create the various sets of text strings. This can lead to inefficiencies in the development cycle. Another disadvantage is that if an entity implementing the software application decides to transition to another terminology, it may require obtaining a new version of the software for the same application.

Various examples described herein address these and other challenges by utilizing a software application, such as an ERP application, comprising an application layer, a verticalization layer, in the verticalization data structure. The application layer may comprise code for implementing the various processes of the software application. The application layer code may include various source objects. A source object is an instance of an application component that includes human-readable text. Example source objects may include messages, user interface screens, fields at user interface screens, and/or the like. The application layer may be arranged to render source objects as the source objects are needed during execution. For example, when a user interface is to provide a screen to a user, the application layer may render the source objects on that screen and provide the screen, with the rendered source objects.

The application layer may be configured to render the source objects using one or more text strings stored at the verticalization data structure, which may be managed by the verticalization layer. For example, after receiving an indication to render a source object, the application layer may query the verticalization data structure to obtain one or more text strings associated with the source object and a current terminology. The application layer may utilize the received text string or strings to render the source object and then provide the rendered source object to one or more users, for example, at a hardware display.

The verticalization data structure may include one or more views, tables, and/or other suitable data structures storing text strings in association with corresponding source objects and terminologies. In response to a query from the application layer, the verticalization layer may identify one or more text strings at the verticalization data structure that correspond to the currently implemented terminology and language. The verticalization layer may provide the returned text strings to the application layer for use in rendering the source object.

The verticalization data structure, in some examples, is updatable to modify the terminology that is being used with the software application at any given time. For example, the verticalization layer may store and/or access one or more verticalization objects. A verticalization object may be a transport object that is and/or includes a data structure used to communicate, in this example, text strings. For example, a verticalization object may be specific to a category of source objects, referred to herein as a source, and a corresponding terminology. In some examples, a verticalization object comprises a header table and a content table. The header table may comprise an indication of source and terminology associated with the verticalization object. The content table may include text strings associated with various source objects of the corresponding source. In various examples, the verticalization layer may be configured to import verticalization objects and utilize imported verticalization objects to update the verticalization data structure and, thereby, change the terminology being used by the ERP application.

The disclosed arrangement may provide various advantages. For example, in some example implementations, an arrangement utilizing an application layer and a verticalization layer as described herein may support compartmentalization of code development and language development for software applications. For example, the work of the software developers coding the application may be completed independently from the work of the linguistics professionals who generate the human-readable text strings. The completed work of linguistics professionals, in some examples, may be incorporated into the completed application as verticalization objects via the verticalization layer. Also, the software application may more easily support modifications to the text string or strings utilized for different terminologies after development. Additionally, users of the ERP application may be provided with functionality to modify the terminology used by the ERP application, for example, to update the terminology and/or if the needs of the user change.

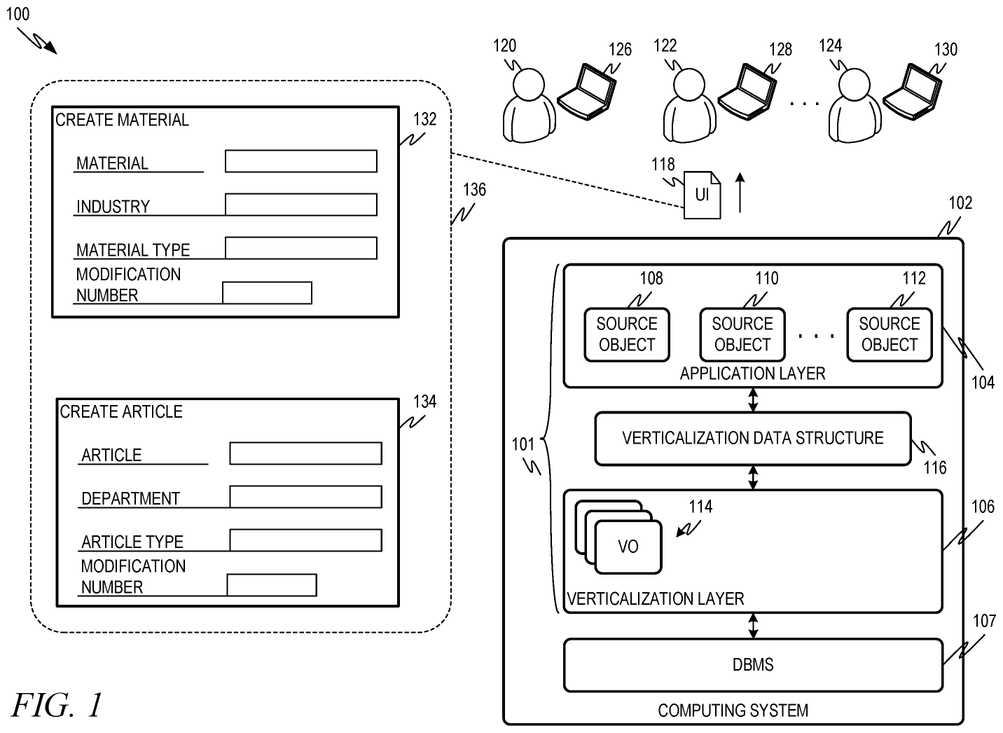

FIG. 1 is a diagram showing one example of an environment 100 comprising a computing system 102 executing an ERP application 101 and conjunction with a DBMS 107. In some examples, the ERP application 101 and DBMS 107 may be provided as a common product such as, for example, the S/4 HANA product available from SAP SE of Waldorf, Germany. Also, although the environment 100 of FIG. 1 includes an ERP application 101, it will be appreciated that the structure and techniques described with respect to FIG. 1 and herein may be applied to other types of software applications as well.

The computing system 102 may be implemented in an on-premise environment and/or in a cloud environment. In an on-premise environment, an enterprise utilizing the ERP application 101 and DBMS 107 may maintain the computing system 102 as an on-premise computing system. The ERP application 101 and DBMS 107 may be executed at the on-premise computing system.

In a cloud environment, the analytics computing system 102 is implemented by one or more servers and/or other computing devices maintained by a cloud provider and accessible remotely. In a private cloud environment, the enterprise using the computing system 102 may provide applications, implement storage, and/or the like to implement the ERP application 101 and DBMS 107. In a public cloud environment, a cloud provider may maintain the computing system 102 and provide a number of tenancies. The cloud provider may provide and maintain executables to implement the ERP application 101 and DBMS 107. An enterprise may purchase a tenancy to permit users associated with that enterprise to access the computing system 102 to use the ERP application 101 and DBMS 107.

Users 120, 122, 124 may access the computing system 102 to interact with the ERP application 101 and DBMS 107. In some examples, users 120, 122, 124 may utilize user computing devices 126, 128, 130 to communicate with the computing system 102. User computing devices 126, 128, 130 may be and/or include various different types of computing devices such as, for example, desktop computers, laptop computers, tablet computers, mobile computing devices, and/or the like. It will be appreciated, that in some non-premise applications, a user may access the computing system 102 directly via input/output components of the computing system 102 such as, for example, a keyboard and/or a monitor.

The ERP application 101 comprises an application layer 104, a verticalization layer 106, and a verticalization data structure 116. The application layer 104 may comprise code that, when executed at the computing system 102, performs and/or supports various enterprise operations, for example, as described herein. The application layer 104 may also be implemented to include various source objects 108, 110, 112. Source objects 108, 110, 112 are instances of text that are provided to users 120, 122, 124 during execution of the application layer 104. The application layer 104 may be configured to utilize source objects 108, 110, 112 to generate a user interface 118. The user interface 118 is provided to users 120, 122, 124 via user computing devices 126, 128, 130 and/or directly via an input/output device of the computing system 102.

Verticalization data structure 116 may comprise text strings associated with the various source objects 108, 110, 112 for different terminologies. The application layer 104 may query the verticalization data structure 116 to receive In some examples, the verticalization data structure 116 may interface with the DBMS 107 to retrieve relevant text strings for a given source object 108, 110, 11 and terminology. Verticalization layer 106 may manage and/or update the verticalization data structure 116, for example, as described herein.

FIG. 1 also shows a breakout window 136 including two screens 132, 134 that may be provided to users 120, 122, 124 as part of the user interface 118. The screens 132, 134 are different versions of a common screen, albeit rendered with different terminologies. For example, the screens 132, 134 may be rendered from the same source object 108, 110, 112 using the same application layer code and may interact with other aspects of the application layer 104 in the same way. In the example shown in FIG. 1, the screens 132, 134 are for creating an item at the DBMS 107. The screen 132 is arranged according to a terminology for implementing entities that are in a manufacturing line of business. The screen 132 is labeled with a text string “create material.” Other text strings rendered at the screen 132 also refer to “material,” “industry,” and other manufacturing-related terms. A user 120, 122, 124 associated with a manufacturing entity may utilize the screen 132, as configured, to create a class of materials at the DBMS 107.

The screen 134 is arranged according to a terminology for implementing entities that are in a retail sales line of business. The screen 134 is labeled with a text string “create article.” Other text strings rendered at the screen 134 also referred to “article,” “department,” and other retail-related terms. A user 120, 122, 124 associated with a retail entity may utilize the screen 134, as configured, to create a class of articles at the DBMS 107.

The screens 132, 134 may be rendered by the application layer 104 from a common source object 108, 110, 112. Upon receiving a request to render a source object 108, 110, 112, the application layer 104 may query the verticalization data structure 116 to obtain text strings associated with the source object 108 and the desired terminology. For example, the application layer 104 may query a verticalization data structure 116 by providing an indication of the source object 108, 110, 112. The verticalization data structure 116 may return a set of one or more text strings that are associated with the relevant source object 108, 110, 112. The application layer 104 may render the source object 108, 110, 112 utilizing the text strings received from the verticalization data structure 116.

The verticalization layer 106 may maintain the verticalization data structure 116 in accordance with a currently-selected terminology. For example, when the ERP application 101 is configured to implement a manufacturing-oriented terminology, for example, as shown in screen 132, the verticalization layer 106 may maintain the verticalization data structure 116 to include text strings for the various source objects 108, 110, 112 that are from the manufacturing-oriented terminology. Similarly, when the ERP application 101 is configured to implement other terminologies, such as, for example the retail-oriented terminology shown in screen 134, the verticalization layer 106 may maintain the verticalization data structure 116 to include text strings for the various source objects 108, 110, 112 that are from the selected terminology.

In various examples, the verticalization layer 106 may utilize various verticalization objects 114. Verticalization objects 114 are transport objects that include text strings associated with one or more source objects 108, 110, 112. In some examples, each verticalization object includes text strings and/or a set of source objects belonging to a common category and/or class of source objects. A category and/or class of source objects may be referred to as a source. For example, a source may comprise a set of one or more source objects 108, 110, 112 belonging to a common class and/or category.

A verticalization object 114 may comprise a header table and a content table. The header table may comprise an indication of a source object 108, 110, 112 associated with the verticalization object 114 and an indication of the terminology reflected by the verticalization object 114. For example, the header table may indicate a source (e.g., class and/or category of source objects 108, 110, 112) that is described by the verticalization object 114.

The content table of a verticalization object 114 may comprise text strings that can be used to render source objects of the source associated with the verticalization object 114 according to the indicated terminology. In some examples, the verticalization layer 106 may comprise (at least) two verticalization objects 114 associated with the source object 108, 110, 112 for rendering the screens 132, 134. A first verticalization object may comprise text strings for rendering the source object 108, 110, 112 in the manner indicated by screen 132. A second verticalization object 114 may comprise text strings for rendering the source object 108, 110, 112 in the manner shown by the screen 134. The verticalization layer 106 may utilize the verticalization objects 114 to modify the verticalization data structure 116 in accordance with a selected terminology.

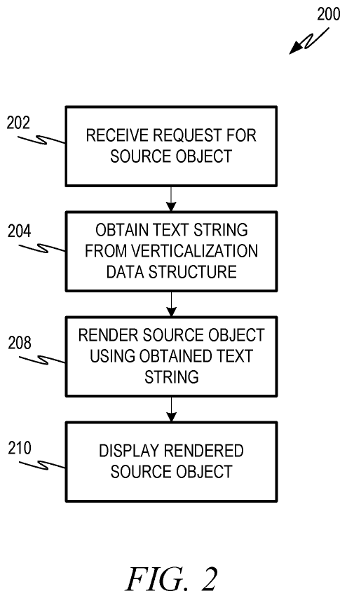

FIG. 2 is a flowchart showing one example of a process flow 200 that may be executed in the environment 100 of FIG. 1 to provide a rendered source object to a user 120, 122, 124. At operation 202, the application layer 104 may receive a request for a source object 108, 110, 112. At operation 204, the application layer 104 may obtain one or more text strings associated with the requested source object 108, 110, 112. The application layer 104 may obtain the one or more text strings from the verticalization data structure 116.

At operation 208, the application layer 104 may render the requested source object 108, 110, 112 using the text strings obtained from the verticalization data structure 116. As described herein, the verticalization layer 106 may maintain the verticalization data structure 116 to include text strings from a currently-implemented terminology. Accordingly, the application layer 104 may render the requested source object 108, 110, 112 in accordance with the currently implemented terminology. At operation 210, the application layer 104 may display the rendered source object to one or more users 120, 122, 124. This may include, for example, serving the rendered source object to be displayed at a display of a user computing device 126, 128, 130 and/or displaying the rendered source object at a display associated with computing system 102.

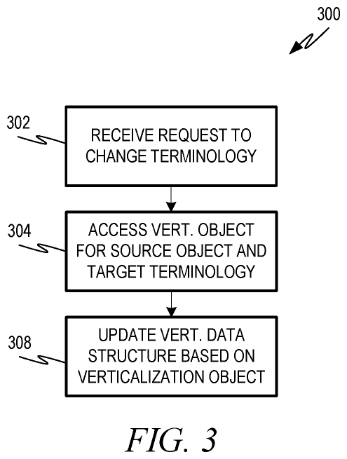

FIG. 3 is a flowchart showing one example of a process flow 300 that may be executed in the environment 100 of FIG. 1 to change the terminology being implemented by the ERP application 101. At operation 302, the verticalization layer 106 may receive a request to change the terminology being implemented by the ERP application 101 from a current terminology to a new terminology. At operation 304, the verticalization layer 106 may access one or more verticalization objects 114 associated with the new terminology. At operation 308, the verticalization layer 106 may update the verticalization data structure 116 to include one or more text strings from the new terminology, as retrieved from the one or more verticalization objects accessed at 304.

As described herein, a verticalization object 114 may relate to fewer than all of the source objects 108, 110, 112 of the application layer 104. For example, the source objects 108, 110, 112 may be instances of different sources (e.g., categories and/or classes of source objects). The verticalization layer 106 may access a verticalization object 114 and update the verticalization data structure 116 for each source (e.g., classification and/or category of source objects) that is to be used by the application layer 104 according to the new terminology. Accordingly, the verticalization layer 106 may access a number of verticalization objects 114 that collectively correspond to all of the source objects 108, 110, 112 that are to be updated to the new terminology.

Updating the verticalization data structure 116 may include replacing at least one text string at the verticalization data structure 116 with at least one replacement text string associated with the new terminology. In some examples, this may include replacing the entirety of the verticalization data structure 116 with a new verticalization data structure associated with the new terminology. In some examples in which the verticalization data structure 116 comprises a delta table, a source table, and a view data structure, this may include replacing an existing delta table with a new delta table associated with the new terminology and recomputing the view data structure. Also, in some examples, updating the verticalization data structure 116 may include replacing individual text strings at the verticalization data structure 116 on a string-by-string basis. In examples in which the verticalization data structure 116 comprises a delta table, a source table, and a view data structure, this may include replacing one or more strings at the delta table and recomputing the view data structure.

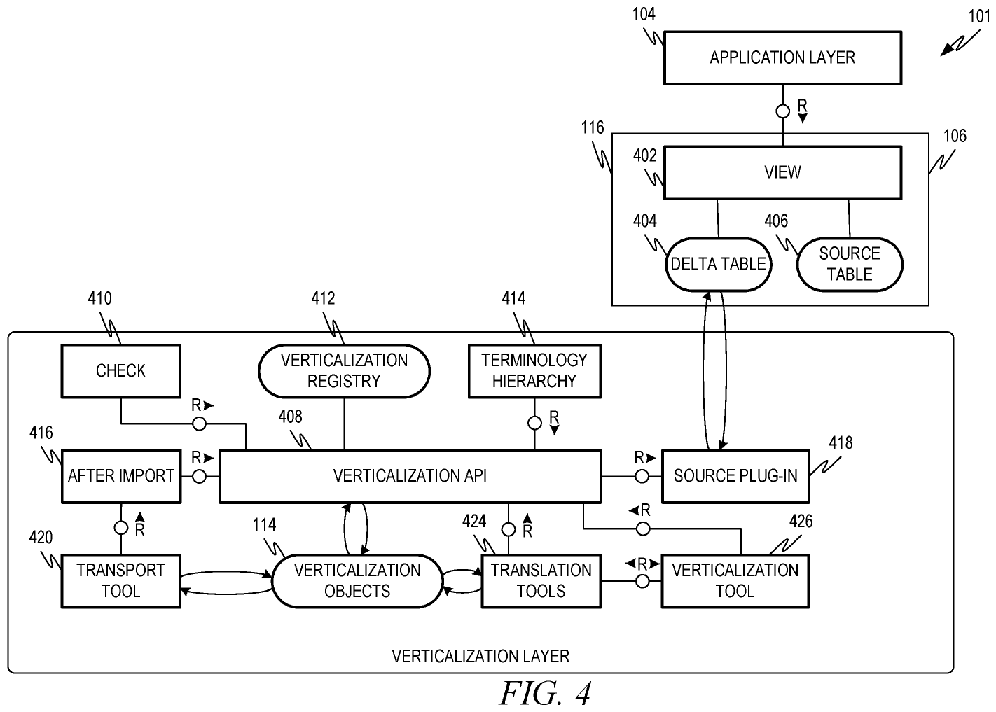

FIG. 4 is a diagram showing one example implementation of the ERP application 101. FIG. 4 illustrates the application layer 104 in communication with an example configuration of the verticalization layer 106 and verticalization data structure 116. In this example, the verticalization data structure 116 comprises a view data structure 402 that is generated from two tables: a source table 406 and a delta table 404. In this example, the source table 406 may comprise a set of text strings corresponding to the various source objects 108, 110, 112 of the application layer 104. The source table 406, for example, may include text strings that are associated with a source terminology. Delta table 404 may comprise text strings of an implemented terminology that differ from the corresponding text strings of the source terminology. The view data structure 402 may include text strings from the delta table 404 as well as text strings from the source table 406 that do not have corresponding strings in the delta table 404. As a result, the view data structure 402 may comprise a set of text strings representing the implemented terminology.

Returning to the example of FIG. 1, consider an example in which the manufacturing terminology illustrated by screen 132 is the source terminology and the terminology illustrated by screen 134 is the implemented terminology. In this example, the source table 406 may have an entry indicating the term “material” and associated with the source object 108, 110, 112 implemented by screens 132, 134. The delta table 404 may have an entry indicating the term “article” and associated with the source object 108, 110, 112 implemented by screens 132, 134. The view data structure 402 may be generated to include the entry “article” from the delta table 404, thus causing the application layer 104 to render the source object 108, 110, 112 as indicated by screen 134.

FIG. 4 also shows an example arrangement including other components of the verticalization layer 106. For example, FIG. 4 shows a verticalization application programming interface (API) 408. Verticalization API 408 may receive requests from other components of the verticalization layer 106 and manage the operations of the verticalization layer 106 in response to the requests.

A verticalization registry 412 may comprise data describing all sources (e.g., classes and/or categories of source objects 108, 110, 112) that have (or can have) associated verticalization objects 114. The verticalization registry 412 may indicate the name of a source, details about the source, and a source plug-in class from a source plug-in 418 that is associated with the source object. The source plug-in class from the source plug-in 418 may divide a process for maintaining and/or updating verticalization registry 412. The verticalization registry 412 may also comprise data about verticalization objects 114 corresponding to various sources. For example, the verticalization registry 412 may indicate, for each combination of a source and a verticalization object 114, the name of the terminology implemented by the verticalization object 114, the name of a language implemented by the verticalization object 114, and/or the like.

The source plug-in 418 may comprise various processes that may be executed at the verticalization layer 106 to access and maintain the verticalization data structure 116. Example processes include a “get instance” process that returns an instance of a verticalization object. A “get object name” process may be used to return a unique name and/or a verticalization object 114 that does not yet exist in the verticalization layer 106. A “get key” process may return a key that can be used to identify an entry in the delta table 404 and/or a form based on a corresponding entry at the source table 406. An “update delta table” process may update the delta table 404 based on the contents of a verticalization object 114. A “check consistency” process may check the consistency of a verticalization object including, for example, verifying the existence of source objects referred to by the verticalization object, checking the uniqueness of the verticalization object, and/or checking the formatting of text at the verticalization object.

A terminology hierarchy 414 may comprise a listing of terminologies that are supported by the verticalization layer 106. For example, the terminology hierarchy 414 may be queried, for example, via the verticalization API 408, to provide an indication of the terminologies that can be selected based on verticalization objects 114 that have been imported to the verticalization layer 106.

A verticalization tool 426 may be utilized to create a new verticalization object 114 at the verticalization layer 106. For example, the verticalization tool 426 may be configured to generate a unique name for a new verticalization object 114 as the verticalization object 114 is added to the verticalization layer 106. A translation tool 424 may be configured to translate text strings, for example, at the content table of the verticalization object, into different human languages. In this way, it may be possible to operate the verticalization layer 106 with one verticalization object 114 for each desired combination of a source and a terminology.

An after import tool 416 and transport tool 420 are processes that may be used to import the new verticalization objects 114 to the verticalization layer 106. For example, the transport tool 420 may be used to acquire and store verticalization objects 114, for example, from an administrative user of the ERP application 101. The after import tool 416 may be configured to cause an update of the delta table 404 based on the import of a verticalization object 114. An check tool 410 may perform various consistency checks on verticalization objects 114. This may include, for example, checking for the existence of the source object or source objects referenced at the header table of the verticalization object 114, checking the uniqueness of the verticalization object 114, verifying that text strings in the content table of the verticalization object adhere to maximum and/or minimum lengths, and/or the like.

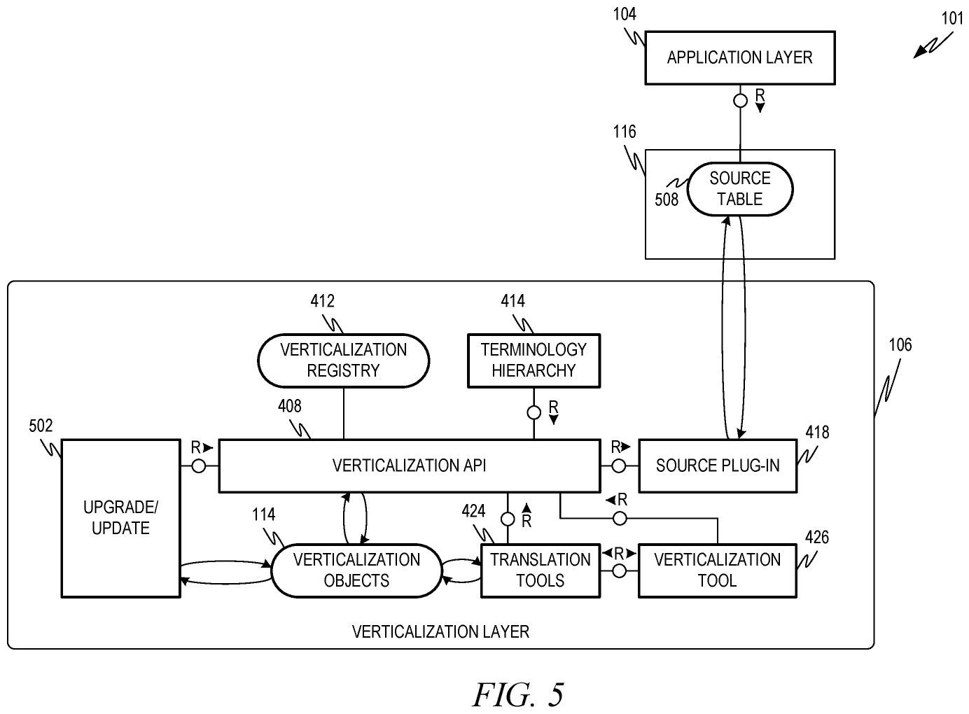

FIG. 5 is a diagram showing another example implementation of the ERP application 101. FIG. 5 illustrates the application layer 104 in communication with an example configuration of the verticalization layer data structure 116. In the example of FIG. 5, the verticalization data structure 116 is implemented as a single source table 508. Source table 508 may include all text strings that are used to render source objects 108, 110, 112 at the application layer 104. In some examples, the source table 508 includes all text strings that are used to render source objects 108, 110, 112 that are part of a common source.

In the example of FIG. 5, the verticalization API 408 and various processes of the source plug-in 418 may implement a terminology at the verticalization layer 106 by modifying the entries in the source table 508 corresponding to a desired terminology. For example, the verticalization API 408 may call a relevant process from the source plug-in 418 and utilize the verticalization tool 426 and/or translation tool 424 to access a verticalization object 114 corresponding to a desired new terminology. The relevant process from the source plug-in 418 may copy text strings from the content table of the verticalization object 114 to the source table 508.

In the example of FIG. 5, an upgrade/update tool 502 may be used in a manner similar to that of the after import tool 416 and the transport tool 420 import the new verticalization objects 114. In some examples, the upgrade/update tool 502 may also be used to update the source table 508 upon receipt of a new verticalization object 114 (e.g., a new verticalization object relating to a currently implemented terminology).

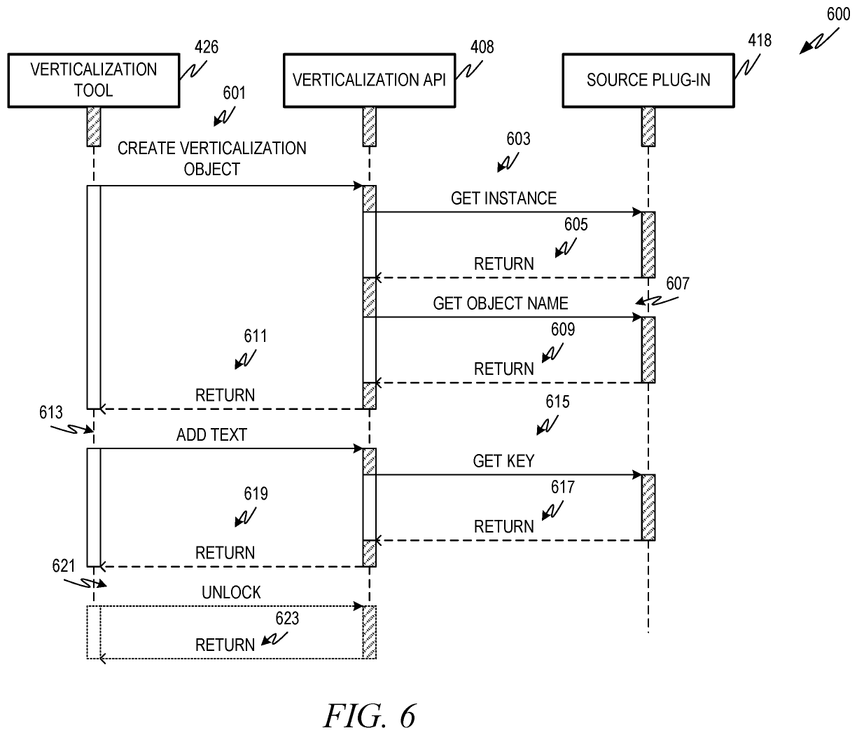

FIG. 6 is a flowchart showing one example of a process flow 600 that may be implemented by the verticalization layer 106 to create a new verticalization object 114. The process flow 600 is illustrated with three different example actors: the verticalization tool 426, the verticalization API 408, and the source plug-in 418. Verticalization tool 426 may make a call 601 to create a verticalization object 114. For example, the verticalization tool 426 may be accessible to one or more of the users 120, 122, 124, thereby allowing the users 120, 122, 124 to create and/or modify a verticalization object 114. For example, a user 120, 122, 124 may direct the verticalization tool 426 to make the call 601. In some examples, the verticalization API 408 may respond to the request by locking a portion of the verticalization data structure 116 that corresponds to the new verticalization object to be created. For example, in the example arrangement shown in FIG. 4, the verticalization API 408 may lock entries in the delta table 404 that relate to the verticalization object 114 to be created. Also, in the example shown in FIG. 5, the verticalization API 408 may lock entries of the source table 508 that relate to the verticalization object to be created. Also, in some examples utilizing an arrangement similar to that shown in FIG. 5, the source table 508 may not be locked.

In response to the request to create a verticalization object, the verticalization API 408 may make a call 603 to a “get instance” process of the source plug-in 418. The process of the source plug-in 418 may be part of a class of the source plug-in 418 that is specific to the verticalization object 114 and/or the source associated with the verticalization object 114 being created. The call 603 may include data identifying the verticalization object 114 to be modified or created. The source plug-in 418 may provide a return 605 that indicates an instance of a plug-in class associated with the verticalization object 114 to be modified and/or created.

The instance of the plug-in class indicated by the return 605 may be used by the verticalization API 408 to perform additional operations. For example, the verticalization API 408 may make a call 607 to a “get object name” process of the plug-in class indicated by the return 605. The source plug-in 418 may provide a return 609 including a valid object name for the new verticalization object 114. The returned object name may be a unique name. In some examples, the object name may be less than 30 characters. The verticalization API 408 may provide a return 611 to the verticalization tool 426 indicating the object name of the new verticalization object 114.

The verticalization tool 426 may provide and “add text” call 613 to the verticalization API 408. The add text call 613 may include one or more text strings to be included in the new verticalization object 114. In response to the “add text” call 613, the verticalization API 408 may write the received one or more text strings to the new verticalization object 114. The verticalization API 408 may also make a “get key” call 615 to the source plug-in 418. In response to the “get key” call 615, the source plug-in 418 may execute a process to return a key that may be used to identify an entry in the source table 508 and/or the delta table 404 that will correspond to the text string provided by the “add text” call 613. The source plug-in 418 may provide a return 617 to the verticalization API 408 indicating the key. The verticalization API 408 may also provide a return 619 to the verticalization tool 426 indicating the key. The verticalization tool 426 and/or other suitable tool at the verticalization layer 106 may utilize the key to update the verticalization data structure 116 to reflect the new verticalization object 114. This may occur, for example, upon the implementation of a new terminology for the application layer 104.

In some examples, the verticalization tool 426 may send an optional “unlock” call 621 to the verticalization API. For example, the “unlock” call 621 may be sent in examples in which the verticalization API 408 locked all or a portion of the verticalization data structure 116 upon receiving the call 601 to create the source verticalization object 114. The verticalization API 408 may unlock the locked portions of the verticalization data structure 116 and provide a return 623 indicating the unlocking.

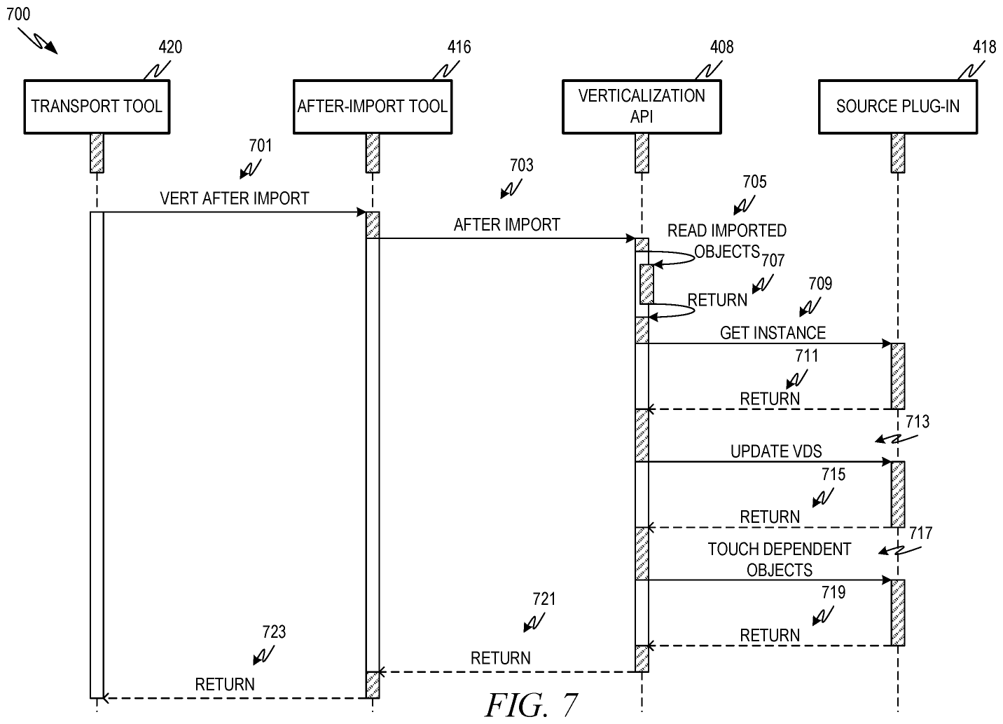

FIG. 7 is a flowchart showing one example of a process flow 700 that may be executed by the verticalization layer 106 to import a verticalization object 114. The process flow 700 includes operations performed by the transport tool 420, the after-import tool 416, the verticalization API 408, and source plug-in 418. For example, calls to the source plug-in 418 may invoke processes of the source plug-in that are part of a class of the source plug-in 418 that is specific to the imported verticalization object 114 and/or the source associated with the imported verticalization object 114.

The transport tool 420 may provide a call 701 to the after import tool 416. The call 701 may invoke the after import tool 416, which may send its own after input call 703 to a verticalization API 408. In response to the after input call 703, the verticalization API 408 may read one or more imported verticalization objects 114 at 705. The verticalization API 408 may provide a return 707 upon completing the reading of the imported verticalization object or objects.

The verticalization API 408 may make a call 709 to a “get instance” process of the source plug-in 418. Source plug-in 418 may determine a unique identifier associated with the imported verticalization object 114 and provide the unique identifier at return 711. Verticalization API 408 may, in some examples, make a call 713 to an “update the verticalization data structure” process of the source plug-in 418. In response, the source plug-in 418 may utilize the imported verticalization object 114 to update the verticalization data structure 116 and provide a return 715 indicating that the verticalization data structure 116 has been updated. In examples having a verticalization data structure 116 implemented in the manner shown in FIG. 4, this may include updating the delta table 404 and regenerating the view data structure 402. In examples having a verticalization data structure 116 implemented in the manner shown in FIG. 5, this may include updating the source table 508.

In some examples, the verticalization API 408, after updating verticalization data structure 116, may make a call 717 to a “touch dependent objects” process of the source plug-in 418. In response, the source plug-in 418 may clear any system caches that referred to previous versions of the imported verticalization object 114. Source plug-in 418 may provide a return 719 upon completion. In response to the return 719, the verticalization API 408 may provide a return 721 to the after-import tool 416. In response to the return 721, the after-import tool 416 may provide a return 723 to the transport tool 420. It will be appreciated that, in some examples, the functionalities of the transport tool 420 and the after-import tool 416 may be consolidated into a single component such as, for example, the upgrade/update tool 502 shown in FIG. 5

### Examples

Example 1 is a computing system configured to provide a user interface, the computing system comprising: at least one processor programmed to execute operations comprising: executing a software application comprising a plurality of source objects, the plurality of source objects comprising a first source object that is renderable with at least one text string: receiving, by the software application, a request for the first source object: querying, by the software application, a verticalization data structure for at least one text string associated with the first source object: rendering, by the software application, the first source object to generate a rendered first source object comprising the at least one text string: displaying, by the software application, the rendered first source object at a hardware display: receiving, by a verticalization layer executing at the computing system, a request to modify a terminology used by the software application to render source objects from a first terminology to a second terminology: accessing, by the verticalization layer, a verticalization object associated with the first source object and the second terminology to obtain at least one second terminology text string associated with the first source object and a modified terminology; and replacing, by the verticalization layer, the at least one text string at the verticalization data structure with the at least one second terminology text string.

In Example 2, the subject matter of Example 1 optionally includes the replacing of the at least one text string at the verticalization data structure with the at least one second terminology text string comprising writing the at least one second terminology text string over the at least one text string.

In Example 3, the subject matter of any one or more of Examples 1-2 optionally includes the verticalization data structure comprising a view data structure generated from a source table and a first delta table, the source table comprising a set of source text strings, and the first delta table comprising a set of first terminology text strings associated with the first terminology.

In Example 4, the subject matter of Example 3 optionally includes the operations further comprising generating the view data structure from the source table and the first delta table.

In Example 5, the subject matter of any one or more of Examples 3-4 optionally includes the replacing of the at least one text string at the verticalization data structure with the at least one second terminology text string comprising: replacing the first delta table with a second delta table associated with the second terminology, the second delta table being based at least in part on the verticalization object; and generating an updated view data structure from the source table and the second delta table.

In Example 6, the subject matter of any one or more of Examples 1-5 optionally includes the verticalization object comprising a header table and a content table, the header table comprising an indication of the first source object and the second terminology, the content table comprising the at least one second terminology text string.

In Example 7, the subject matter of Example 6 optionally includes the operations further comprising: receiving, by a verticalization application programming interface (API) executing at the computing system, a request to create a new verticalization object associated with the first source object and a third terminology: calling, by the verticalization API, a source plug-in to return a name for the new verticalization object; and receiving, by the verticalization API, a new text string to the new verticalization object.

In Example 8, the subject matter of any one or more of Examples 1-7 optionally includes the operations further comprising: receiving, by a verticalization application programming interface (API) executing at the computing system, a new verticalization object associated with the first source object and a third terminology: calling, by the verticalization API, a source plug-in to import the new verticalization object; and calling, by the verticalization API, a source plug-in to update the verticalization data structure based on the new verticalization object.

Example 9 is a method of generating a user interface for a user of a computing system, the method comprising: executing a software application comprising a plurality of source objects, the plurality of source objects comprising a first source object that is renderable with at least one text string; receiving, by the software application, a request for the first source object; querying, by the software application, a verticalization data structure for at least one text string associated with the first source object: rendering, by the software application, the first source object to generate a rendered first source object comprising the at least one text string: displaying, by the software application, the rendered first source object at a hardware display: receiving, by a verticalization layer executing at the computing system, a request to modify a terminology used by the software application to render source objects from a first terminology to a second terminology: accessing, by the verticalization layer, a verticalization object associated with the first source object and the second terminology to obtain at least one second terminology text string associated with the first source object and a modified terminology; and replacing, by the verticalization layer, the at least one text string at the verticalization data structure with the at least one second terminology text string.

In Example 10, the subject matter of Example 9 optionally includes the replacing of the at least one text string at the verticalization data structure with the at least one second terminology text string comprising writing the at least one second terminology text string over the at least one text string.

In Example 11, the subject matter of any one or more of Examples 9-10 optionally includes the verticalization data structure comprising a view data structure generated from a source table and a first delta table, the source table comprising a set of source text strings, and the first delta table comprising a set of first terminology text strings associated with the first terminology.

In Example 12, the subject matter of Example 11 optionally includes generating the view data structure from the source table and the first delta table.

In Example 13, the subject matter of any one or more of Examples 11-12 optionally includes the replacing of the at least one text string at the verticalization data structure with the at least one second terminology text string comprising: replacing the first delta table with a second delta table associated with the second terminology, the second delta table being based at least in part on the verticalization object; and generating an updated view data structure from the source table and the second delta table.

In Example 14, the subject matter of any one or more of Examples 9-13 optionally includes the verticalization object comprising a header table and a content table, the header table comprising an indication of the first source object and the second terminology, the content table comprising the at least one second terminology text string.

In Example 15, the subject matter of Example 14 optionally includes receiving, by a verticalization application programming interface (API) executing at the computing system, a request to create a new verticalization object associated with the first source object and a third terminology: calling, by the verticalization API, a source plug-in to return a name for the new verticalization object; and receiving, by the verticalization API, a new text string to the new verticalization object.

In Example 16, the subject matter of any one or more of Examples 9-15 optionally includes receiving, by a verticalization application programming interface (API) executing at the computing system, a new verticalization object associated with the first source object and a third terminology: calling, by the verticalization API, a source plug-in to import the new verticalization object; and calling, by the verticalization API, a source plug-in to update the verticalization data structure based on the new verticalization object.

Example 17 is a non-transitory machine-readable medium comprising instructions thereon that, when executed by at least one processor, cause the at least one processor to perform operations comprising: executing a software application comprising a plurality of source objects, the plurality of source objects comprising a first source object that is renderable with at least one text string: receiving, by the software application, a request for the first source object: querying, by the software application, a verticalization data structure for at least one text string associated with the first source object: rendering, by the software application, the first source object to generate a rendered first source object comprising the at least one text string: displaying, by the software application, the rendered first source object at a hardware display: receiving, by a verticalization layer executing at the at least one processor, a request to modify a terminology used by the software application to render source objects from a first terminology to a second terminology: accessing, by the verticalization layer, a verticalization object associated with the first source object and the second terminology to obtain at least one second terminology text string associated with the first source object and a modified terminology; and replacing, by the verticalization layer, the at least one text string at the verticalization data structure with the at least one second terminology text string.

In Example 18, the subject matter of Example 17 optionally includes the replacing of the at least one text string at the verticalization data structure with the at least one second terminology text string comprising writing the at least one second terminology text string over the at least one text string.

In Example 19, the subject matter of any one or more of Examples 17-18 optionally includes the verticalization data structure comprising a view data structure generated from a source table and a first delta table, the source table comprising a set of source text strings, and the first delta table comprising a set of first terminology text strings associated with the first terminology.

In Example 20, the subject matter of Example 19 optionally includes the operations further comprising generating the view data structure from the source table and the first delta table.

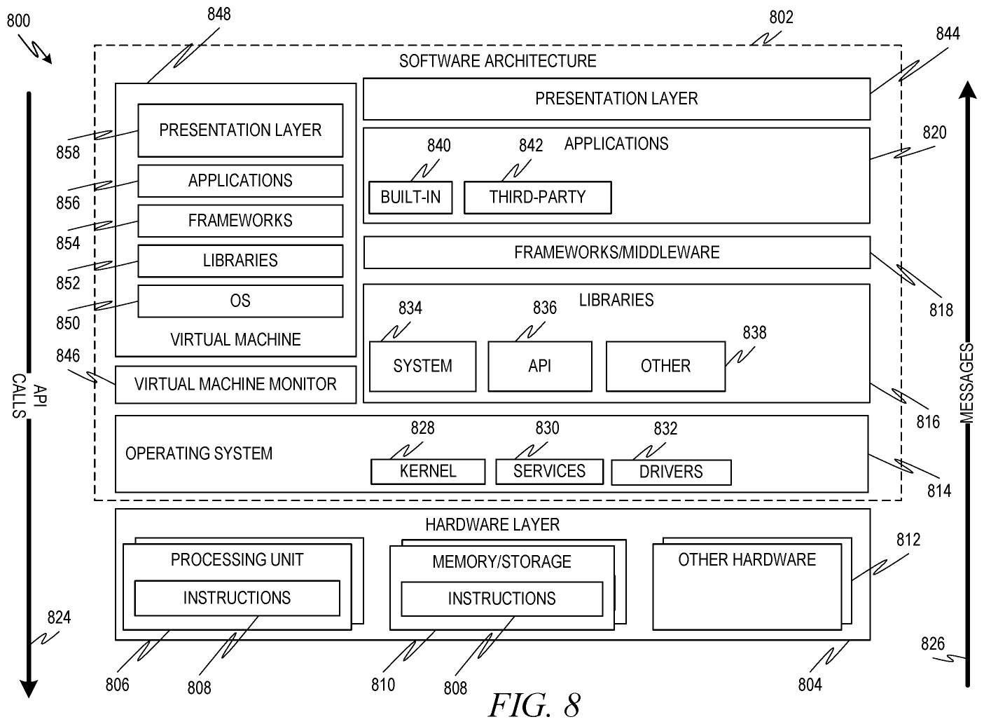

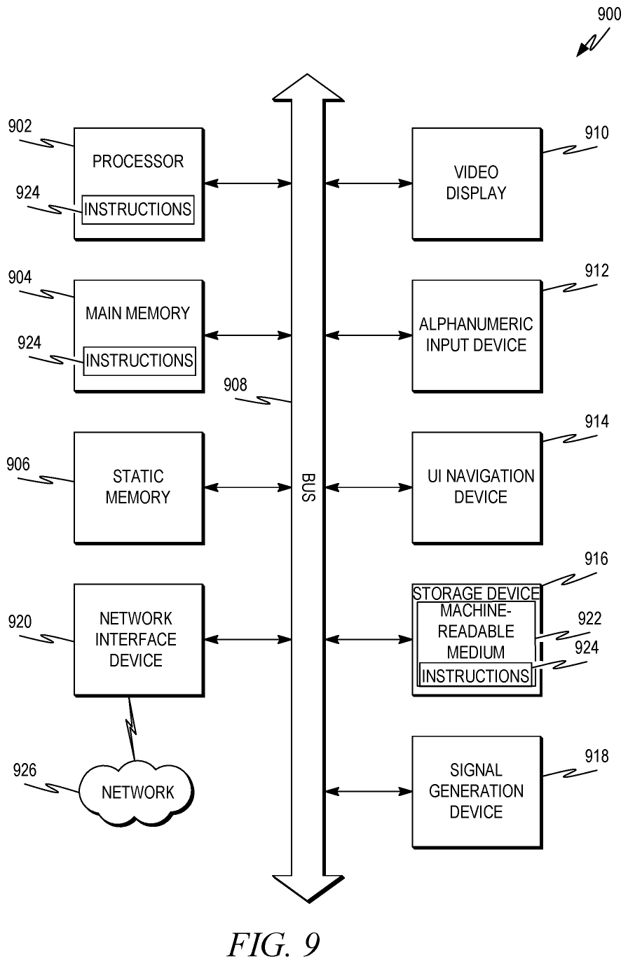

FIG. 8 is a block diagram 800 showing one example of a software architecture 802 for a computing device. The architecture 802 may be used in conjunction with various hardware architectures, for example, as described herein. FIG. 8 is merely a non-limiting example of a software architecture and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 which represents any other hardware of the hardware layer 804, such as the other hardware illustrated as part of the architecture 802.

In the example architecture of FIG. 8, the software architecture 802 may be conceptualized as a stack of layers where each layer provides particular functionality. For example, the software architecture 802 may include layers such as an operating system 814, libraries 816, middleware layer 818, applications 820, and presentation layer 844. Operationally, the applications 820 and/or other components within the layers may invoke API calls 824 through the software stack and access a response, returned values, and so forth illustrated as messages 826 in response to the API calls 824. The layers illustrated are representative in nature and not all software architectures have all layers. For example, some mobile and/or special purpose operating systems may not provide a middleware layer 818, while others may provide such a layer. Other software architectures may include additional and/or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the architecture 802 to pause its current processing and execute an interrupt service routine (ISR) when an interrupt is accessed.

The drivers 832 may be responsible for controlling and/or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The middleware layer 818 (also sometimes referred to as frameworks) may provide a higher-level common infrastructure that may be utilized by the applications 820 and/or other software components/modules. For example, the middleware layer 818 may provide various graphic user interface (GUI) functions, high-level resource management, high-level location services, and so forth. The middleware layer 818 may provide a broad spectrum of other APIs that may be utilized by the applications 820 and/or other software components/modules, some of which may be specific to a particular operating system and/or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built-in operating system functions (e.g., kernel 828, services 830 and/or drivers 832), libraries (e.g., system 834, API libraries 836, and other libraries 838), and middleware layer 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of a machine in the example form of a computer system 900 within which instructions 924 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface navigation (or cursor control) device 914 (e.g., a mouse), a disk drive unit 916, a signal generation device 918 (e.g., a speaker), and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media 922.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices: magnetic disks such as internal hard disks and removable disks: magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computing system configured to provide a user interface, the computing system comprising:
at least one processor programmed to execute operations comprising:
executing a software application comprising a plurality of source objects, the plurality of source objects comprising a first source object that is renderable with at least one text string;
executing a verticalization application programming interface (API);
receiving, by the verticalization API, a verticalization object associated with the first source object and a first terminology;
calling, by the verticalization API, a source plug-in to import the verticalization object;
calling, by the verticalization API, a source plug-in to update a verticalization data structure based on the verticalization object associated with the first source object and the first terminology;
receiving, by the software application, a request for the first source object;
querying the verticalization data structure, by the software application, for at least one text string associated with the first source object;
rendering, by the software application, the first source object to generate a rendered first source object comprising the at least one text string;
displaying, by the software application, the rendered first source object at a hardware display;
receiving, by a verticalization layer executing at the computing system, a request to modify a terminology used by the software application to render source objects from a first terminology to a second terminology;
accessing, by the verticalization layer, a verticalization object associated with the first source object and the second terminology to obtain at least one second terminology text string associated with the first source object and the second terminology; and
replacing, by the verticalization layer, the at least one text string at the verticalization data structure with the at least one second terminology text string.

2. The system of claim 1, the replacing of the at least one text string at the verticalization data structure with the at least one second terminology text string comprising writing the at least one second terminology text string over the at least one text string.

3. The system of claim 1, the verticalization data structure comprising a view data structure generated from a source table and a first delta table, the source table comprising a set of source text strings, and the first delta table comprising a set of first terminology text strings associated with the first terminology.

4. The system of claim 3, the operations further comprising generating the view data structure from the source table and the first delta table.

5. The system of claim 3, the replacing of the at least one text string at the verticalization data structure with the at least one second terminology text string comprising:
replacing the first delta table with a second delta table associated with the second terminology, the second delta table being based at least in part on the verticalization object; and
generating an updated view data structure from the source table and the second delta table.

6. The system of claim 1, the verticalization object comprising a header table and a content table, the header table comprising an indication of the first source object and the second terminology, the content table comprising the at least one second terminology text string.

7. The system of claim 6, the operations further comprising:
receiving, by a verticalization application programming interface (API) executing at the computing system, a request to create a new verticalization object associated with the first source object and a third terminology;
calling, by the verticalization API, a source plug-in to return a name for the new verticalization object; and
receiving, by the verticalization API, a new text string to the new verticalization object.

8. A method of generating a user interface for a user of a computing system, the method comprising:
executing a software application comprising a plurality of source objects, the plurality of source objects comprising a first source object that is renderable with at least one text string;
receiving, by the software application, a request for the first source object;
querying, by the software application, a verticalization data structure for at least one text string associated with the first source object;
rendering, by the software application, the first source object to generate a rendered first source object comprising the at least one text string;
displaying, by the software application, the rendered first source object at a hardware display;
receiving, by a verticalization layer executing at the computing system, a request to modify a terminology used by the software application to render source objects from a first terminology to a second terminology;
accessing, by the verticalization layer, a verticalization object associated with the first source object and the second terminology to obtain at least one second terminology text string associated with the first source object and the second terminology; and
replacing, by the verticalization layer, the at least one text string at the verticalization data structure with the at least one second terminology text string.

9. The method of claim 8, the replacing of the at least one text string at the verticalization data structure with the at least one second terminology text string comprising writing the at least one second terminology text string over the at least one text string.

10. The method of claim 8, the verticalization data structure comprising a view data structure generated from a source table and a first delta table, the source table comprising a set of source text strings, and the first delta table comprising a set of first terminology text strings associated with the first terminology.

11. The method of claim 10, further comprising generating the view data structure from the source table and the first delta table.

12. The method of claim 10, the replacing of the at least one text string at the verticalization data structure with the at least one second terminology text string comprising:
replacing the first delta table with a second delta table associated with the second terminology, the second delta table being based at least in part on the verticalization object; and
generating an updated view data structure from the source table and the second delta table.

13. The method of claim 8, the verticalization object comprising a header table and a content table, the header table comprising an indication of the first source object and the second terminology, the content table comprising the at least one second terminology text string.

14. The method of claim 13, further comprising:
receiving, by a verticalization application programming interface (API) executing at the computing system, a request to create a new verticalization object associated with the first source object and a third terminology;
calling, by the verticalization API, a source plug-in to return a name for the new verticalization object; and
receiving, by the verticalization API, a new text string to the new verticalization object.

15. The method of claim 8, further comprising:
receiving, by a verticalization application programming interface (API) executing at the computing system, a new verticalization object associated with the first source object and a third terminology;
calling, by the verticalization API, a source plug-in to import the new verticalization object; and
calling, by the verticalization API, a source plug-in to update the verticalization data structure based on the new verticalization object.

16. A non-transitory machine-readable medium comprising instructions thereon that, when executed by at least one processor, cause the at least one processor to perform operations comprising:
executing a software application comprising a plurality of source objects, the plurality of source objects comprising a first source object that is renderable with at least one text string;
receiving, by the software application, a request for the first source object;
querying, by the software application, a verticalization data structure for at least one text string associated with the first source object;
rendering, by the software application, the first source object to generate a rendered first source object comprising the at least one text string;
displaying, by the software application, the rendered first source object at a hardware display;
receiving, by a verticalization layer executing at the at least one processor, a request to modify a terminology used by the software application to render source objects from a first terminology to a second terminology;
accessing, by the verticalization layer, a verticalization object associated with the first source object and the second terminology to obtain at least one second terminology text string associated with the first source object and the second terminology; and
replacing, by the verticalization layer, the at least one text string at the verticalization data structure with the at least one second terminology text string.

17. The medium of claim 16, the replacing of the at least one text string at the verticalization data structure with the at least one second terminology text string comprising writing the at least one second terminology text string over the at least one text string.

18. The medium of claim 16, the verticalization data structure comprising a view data structure generated from a source table and a first delta table, the source table comprising a set of source text strings, and the first delta table comprising a set of first terminology text strings associated with the first terminology.

19. The medium of claim 18, the operations further comprising generating the view data structure from the source table and the first delta table.

20. The medium of claim 18, the replacing of the at least one text string at the verticalization data structure with the at least one second terminology text string comprising:
replacing the first delta table with a second delta table associated with the second terminology, the second delta table being based at least in part on the verticalization object; and
generating an updated view data structure from the source table and the second delta table.
